(19) United States
(12) Patent Application Publication
(10) Pub. No.: US 2019/0155907 A1
(43) Pub. Date: May 23, 2019

(54) SYSTEM FOR GENERATING LEARNING SENTENCE AND METHOD FOR GENERATING SIMILAR SENTENCE USING SAME

(71) Applicant: MINDS LAB., INC., Daejeon (KR)

(72) Inventors: Sung Jun PARK, Seoul (KR); Yi Gyu HWANG, Gyeonggi-do (KR); Tae Joon YOO, Incheon (KR); Ki Hyun YUN, Gyeonggi-do (KR)

(73) Assignee: MINDS LAB., INC., Daejeon (KR)

(21) Appl. No.: 16/195,993

(22) Filed: Nov. 20, 2018

(30) Foreign Application Priority Data
Nov. 20, 2017 (KR) 10-2017-0155143

(51) Int. Cl. G06F 17/27

(52) U.S. Cl. CPC G06F 17/2785; G06F 17/2795

(57) ABSTRACT

The present disclosure relates to a system and method of generating a sentence similar to a basis sentence for machine learning. For the same, the similar sentence generating method includes: generating a first similar sentence by using a word similar to a word included in a basis sentence; generating a second similar sentence of the basis sentence or the first similar sentence based on a speaker feature; and determining whether or not the first similar sentence and the second similar sentence are valid.

### CROSS REFERENCE TO RELATED APPLICATION

The present application claims priority to Korean Patent Application No. 10-2017-0155143, filed Nov. 20, 2017, the entire contents of which is incorporated herein for all purposes by this reference.

### BACKGROUND OF THE INVENTION

### Field of the Invention

The present disclosure relates generally to a system and method of generating a sentence similar to a basis sentence for machine learning.

### Description of the Related Art

As voice-based artificial intelligence services become more popular, systems that allow users to get answers to desired questions through dialogue with machines, or to remotely execute desired commands are being widely deployed. In an example, when a question about a specific topic is entered, a QA system providing AI conversation service performs natural language processing for the input question, searches for an answer to the corresponding question, generates response data on the basis of found result, and provides the generated response data by performing voice into text (STT, speech-to-text) for the same. In order to improve quality of AI conversation service, a voice recognition rate has to be improved. In addition, in order to improve quality of AI conversation service, learning of sentences with various forms having the same meaning is also required. As part of this, a method of generating various similar sentences of a specific sentence, and performing learning the generated similar sentences for a machine may be considered.

However, generating artificially and individually similar sentences for a specific sentence is limited in quantity and quality. In addition, when language ability, language characteristics, etc. of a speaker who wishes to use an AI service are not considered, the AI service cannot be used for a specific group in a meaningful manner.

The foregoing is intended merely to aid in the understanding of the background of the present disclosure, and is not intended to mean that the present disclosure falls within the purview of the related art that is already known to those skilled in the art.

### SUMMARY OF THE INVENTION

An object of the present disclosure is to provide a system and method of generating a sentence similar to a basis sentence.

Another object of the present disclosure is to provide a system and method of generating a sentence similar to a basis sentence by taking account into a feature of a speaker.

Technical problems obtainable from the present disclosure are not limited by the above-mentioned technical problems, and other unmentioned technical problems may be clearly understood from the following description by those having ordinary skill in the technical field to which the present disclosure pertains.

According to an aspect of the present disclosure, a learning sentence generating system and a similar sentence generating method generate a first similar sentence by using a word similar to a word included in a basis sentence; generate a second similar sentence of the basis sentence or the first similar sentence based on a speaker feature; and determine whether or not the first similar sentence and the second similar sentence are valid.

According to an aspect of the present disclosure, in the learning sentence generating system and the similar sentence generating method, the speaker feature may be selected based on feature information of a speaker, and the feature information may be a feature related to at least one of an age, a gender, and a region of the speaker.

According to an aspect of the present disclosure, in the learning sentence generating system and the similar sentence generating method, when a plurality of speaker features is selected, the second similar sentence may be generated by using a speaker feature in combination of at least two of the plurality of speaker features.

According to an aspect of the present disclosure, in the learning sentence generating system and the similar sentence generating method, when a plurality of speaker features is selected, at least one second similar sentence may be sequentially generated based on a priority of the plurality of speaker features.

According to an aspect of the present disclosure, in the learning sentence generating system and the similar sentence generating method, the second similar sentence is generated by inserting an interjection to a beginning, an end, and between phrases of the basis sentence or the first similar sentence.

According to an aspect of the present disclosure, in the learning sentence generating system and the similar sentence generating method, the second similar sentence is generated by repeating a word or phrase included in the basis sentence or the first similar sentence.

According to an aspect of the present disclosure, in the learning sentence generating system and the similar sentence generating method, whether or not the first similar sentence and the second similar sentence are valid is determined based on whether or not the first similar sentence is identical to the basis sentence, or whether or not the second similar sentence is identical to the basis sentence or the first similar sentence.

According to an aspect of the present disclosure, in the learning sentence generating system and the similar sentence generating method, whether or not the first similar sentence and the second similar sentence are valid is determined by determining whether or not the first similar sentence and the second similar sentence are an abnormal sentence through N-gram word analysis.

According to an aspect of the present disclosure, in the learning sentence generating system and the similar sentence generating method, N may be variably determined according to feature information of a speaker.

It is to be understood that the foregoing summarized features are exemplary aspects of the following detailed description of the present disclosure without limiting the scope of the present disclosure.

According to the present disclosure, there is provided a system and method of generating a sentence similar to a basis sentence.

According to the present disclosure, there is provided a system and method of generating a sentence similar to a basis sentence by taking account into a feature of a speaker.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view showing a system for generating a learning sentence according to an embodiment of the present disclosure;

FIG. 2 is a view of a flowchart showing a method of generating a learning sentence according to the present disclosure; and

FIG. 3 is a view of a flowchart showing sentence filtering.

### DETAILED DESCRIPTION OF THE INVENTION

As embodiments allow for various changes and numerous embodiments, exemplary embodiments will be illustrated in the drawings and described in detail in the written description.

However, this is not intended to limit embodiments to particular modes of practice, and it is to be appreciated that all changes, equivalents, and substitutes that do not depart from the spirit and technical scope of embodiments are encompassed in the embodiments. The similar reference numerals refer to the same or similar functions in various aspects. The shapes, sizes, etc. of components in the drawings may be exaggerated to make the description clearer. In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a certain feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present disclosure is defined only by the appended claims, appropriately interpreted, along with the full range of equivalents to which the claims are entitled.

It will be understood that, although the terms including ordinal numbers such as “first”, “second”, etc. may be used herein to describe various elements, these elements are not limited by these terms. These terms are only used to distinguish one element from another. For example, a second element could be termed a first element without departing from the teachings of the present inventive concept, and similarly a first element could be also termed a second element. The term “and/or” includes any and all combination of one or more of the associated items listed.

When an element is referred to as being “connected to” or “coupled with” another element, it can not only be directly connected or coupled to the other element, but also it can be understood that intervening elements may be present. In contrast, when an element is referred to as being “directly connected to” or “directly coupled with” another element, there are no intervening elements present.

Also, components in embodiments of the present disclosure are shown as independent to illustrate different characteristic functions, and each component may be configured in a separate hardware unit or one software unit, or combination thereof. For example, each component may be implemented by combining at least one of a communication unit for data communication, a memory storing data, and a control unit (or processor) for processing data.

Alternatively, constituting units in the embodiments of the present disclosure are illustrated independently to describe characteristic functions different from each other and thus do not indicate that each constituting unit comprises separate units of hardware or software. In other words, each constituting unit is described as such for the convenience of description, and1 thus at least two constituting units may from a single unit and at the same time, a single unit may provide an intended function while it is divided into multiple sub-units and an integrated embodiment of individual units and embodiments performed by sub-units all should be understood to belong to the claims of the present disclosure as long as those embodiments belong to the technical scope of the present disclosure.

Terms are used herein only to describe particular embodiments and do not intend to limit the present disclosure. Singular expressions, unless contextually otherwise defined, include plural expressions. Also, throughout the specification, it should be understood that the terms “comprise”, “have”, etc. are used herein to specify the presence of stated features, numbers, steps, operations, elements, components or combinations thereof but do not preclude the presence or addition of one or more other features, numbers, steps, operations, elements, components, or combinations thereof. That is, when a specific element is referred to as being “included”, elements other than the corresponding element are not excluded, but additional elements may be included in embodiments of the present disclosure or the scope of the present disclosure.

Furthermore, some elements may not serve as necessary elements to perform an essential function in the present disclosure, but may serve as selective elements to improve performance. The present disclosure may be embodied by including only necessary elements to implement the spirit of the present disclosure excluding elements used to improve performance, and a structure including only necessary elements excluding selective elements used to improve performance is also included in the scope of the present disclosure.

Hereinafter, embodiments of the present disclosure are described in detail with reference to the accompanying drawings. When determined to make the subject matter of the present disclosure unclear, the detailed description of known configurations or functions is omitted. To help with understanding with the disclosure, in the drawings, like reference numerals denote like parts, and the redundant description of like parts will not be repeated.

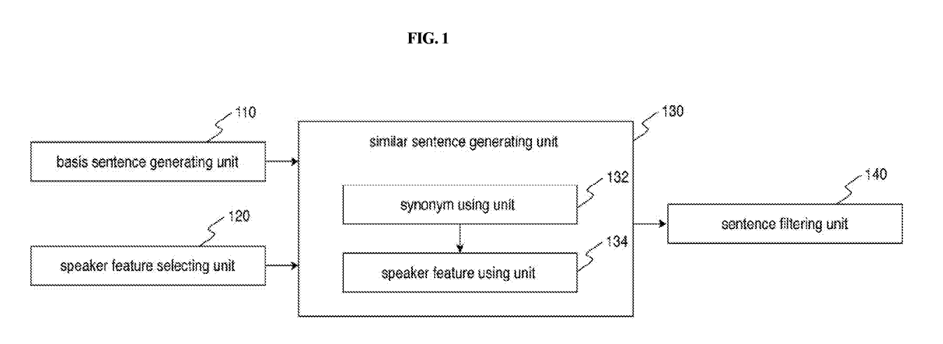

FIG. 1 is a view showing a system for generating a learning sentence according to an embodiment of the present disclosure.

Referring to FIG. 1, a system for generating a learning sentence according to the present disclosure may include a basis sentence generating unit 110, a speaker feature selection unit 120, a similar sentence generating unit 130, and a sentence filtering unit 140.

The basis sentence generating unit 110 generates a basis sentence suitable for a field or theme for machine learning of a machine. A basis sentence may be generated on the basis of a corpus related to a specific field or theme, or may be generated by web data or data collected through machine reading comprehension (MRC), or by data input from outside, etc. Herein, a corpus means language data collected in a manner that a computer reads texts for finding out how language is used. Based on a corpus artificially generated by developer or manager or based on a pre-generated corpus, a basis sentence may be generated where text in a sentence form are collected in a manner whereby a computer reads the same.

The speaker feature selection unit 120 receives feature information of a speaker, and selects a speaker feature in association with the input feature information. A speaker feature relates to language habit of a speaker, and a rule for generating a similar sentence may be defined on the basis of a speaker feature selected in the speaker feature selection unit 120. Herein, a speaker may mean a target that desires to use AI service. In an example, when sentences generated by the present learning sentence generating system are for AI training for older people, feature information of a speaker is set to be proper for older people.

The speaker feature selection unit 120 may select at least one of selectable speaker feature candidates according to input feature information. Herein, a type and a number of speaker features selected by the speaker feature selection unit 120 may be variably determined depending on input feature information.

The similar sentence generating unit 130 generates a sentence similar to a basis sentence. The similar sentence generating unit 130 may include at least one of a synonym using unit 132 generating a similar sentence by using synonym, and a speaker feature using unit 134 generating a similar sentence by using a speaker feature.

In an example, the synonym using unit 132 may obtain a word similar equal to or higher than a certain level compared with a word included in a basis sentence by using word embedding or paraphrasing, and generate a sentence similar to a basis sentence by using the obtained word. In detail, the synonym using unit 132 may generate a sentence similar to a basis sentence by replacing a word or noun included in the basis sentence with a synonym.

In an example, the speaker feature using unit 134 may generate a sentence similar to a basis sentence on the basis of a speaker feature input from the speaker feature selection unit 120. In detail, the speaker feature using unit 134 may generate a sentence similar to a basis sentence on the basis of a rule such as repetition of the same word or interjection insertion, etc. according to a speaker feature.

Generating a similar sentence may be performed stepwisely. In an example, when a sentence similar to a basis sentence is generated in the synonym using unit 132, the speaker feature using unit 134 may generate a similar sentence for a basis sentence and the similar sentence generated in the synonym using unit 132.

On the other hand, when the speaker feature using unit 134 generates a sentence similar to a basis sentence, the synonym using unit 132 may generate a similar sentence for a basis sentence and the similar sentence generated in the speaker feature using unit 134.

Alternatively, one of the synonym using unit 132 and the speaker feature using unit 134 may be used for generating a similar sentence.

The sentence filtering unit 140 determines whether or not the generated similar sentence generated by the similar sentence generating unit 130 is valid. In detail, the sentence filtering unit 140 may remove a similar sentence identical to a basis sentence or a similar sentence identical to a previously generated similar sentence, or remove an abnormal similar sentence by using N-gram word analysis.

Hereinafter, operation of a sentence learning system will be described in detail with reference to the figures.

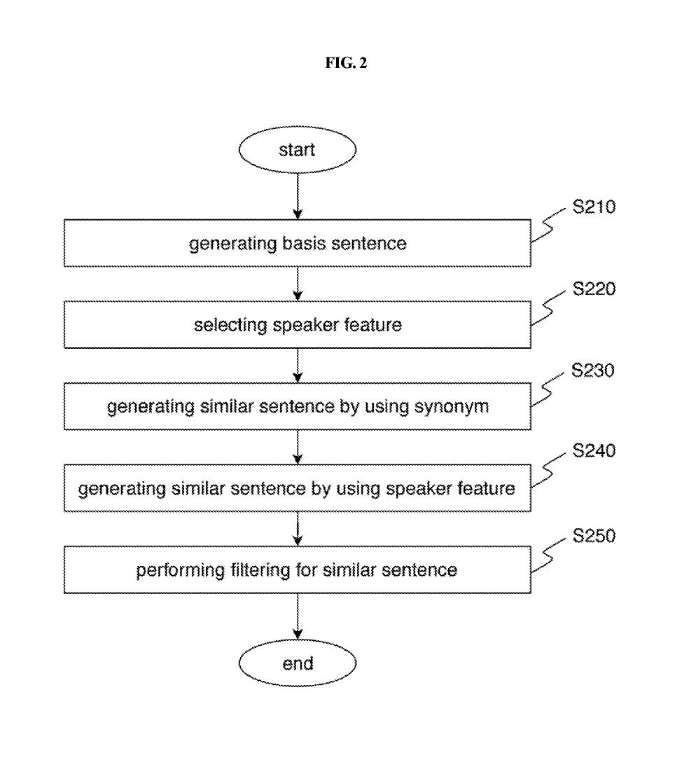

FIG. 2 is a view of a flowchart showing a method of sentence learning according to the present disclosure. For convenience of description, the sentence learning method will be described in a sequence of steps, but the sentence learning method may be implemented in a different order than shown.

In addition, it is assumed that the similar sentence generating unit 130 generates a similar sentence stepwisely. In detail, it is assumed that the synonym using unit 132 primarily generates a similar sentence, and the speaker feature using unit 134 secondarily generates a similar sentence on the basis of a basis sentence and the primarily generated sentence.

First, in S210, the basis sentence generating unit 110 may generate a basis sentence for machine learning. A basis sentence may be generated on the basis of data input from outsize, web data or data collected through MRC. Alternatively, a basis sentence may be generated on the basis of a corpus related to a specific field or theme.

When feature information of a speaker is input to the speaker feature selection unit 120, in S220, the speaker feature selection unit 120 may select a speaker feature on the basis of the input feature information. Herein, feature information of a speaker relates to inborn, regional, and social features which affect language habits or language ability, and may include at least one of an age, a region, a gender, and a job of a speaker.

The speaker feature selection unit 120 may select a speaker feature in association with the input feature information. Herein, a speaker feature may be used as a factor for reflecting a language feature of a specific group such as specific region, specific age, etc. when generating a similar sentence. A speaker feature may include a rule such as repetition, interjection, postposition particle, incomplete/correction, delay, inversion, etc. A plurality of speaker features may be selected according to input feature information.

The similar sentence generating unit 130 may generate a similar sentence of the input basis sentence. First, in S230, the synonym using unit 132 may generate a sentence similar to the basis sentence by using a synonym.

In S240, the speaker feature using unit 134 may generate a similar sentence for the basis sentence and the similar sentence generated in the synonym using unit 132 on the basis of a speaker feature. In detail, the speaker feature using unit 134 may generate a similar sentence on the basis of a rule defined by a speaker feature.

In an example, when repetition is selected as a speaker feature, the speaker feature using unit 134 may generate a similar sentence by repeating a word or phrase included in a sentence. Alternatively, when interjection is selected among speaker features, the speaker feature using unit 134 may generate a similar sentence by inserting an interjection to the beginning, or end of a sentence or between phrases of a sentence. When a postposition particle is selected among speaker features, the speaker feature using unit 134 may generate a similar sentence by adding a postposition particle to a sentence, or omitting a postposition particle included in a sentence. When incomplete/correction is selected among speaker features, the speaker feature using unit 134 may generate a similar sentence by omitting an object or predicate included in a sentence or by correcting to a non-grammatical sentence. When delay is selected among speaker features, the speaker feature using unit 134 may generate a similar sentence by slurring a word included in a sentence. When inversion is selected among speaker features, the speaker feature using unit 134 may generate a similar sentence by performing inversion of word order of a sentence.

According to feature information of a speaker, at least one speaker feature may be selected. In an example, when feature information of a speaker indicates that an age of a speaker corresponds to an older person, a plurality of speaker features such as incomplete/correction, omission, inversion, etc. may be selected by taking account into language habits of older people. When a plurality of speaker features is selected, the speaker feature using unit 134 may generate a similar sentence by separately applying each of the plurality of speaker features, or may generate a similar sentence in combination of at least two speaker features.

Tables 1 and 2 show an example of generating a similar sentence according to a speaker feature. In an example of Tables 1 and 2, it is assumed that a basis sentence is “Ne-il jeom-sim-euro muol meok-ji (What to eat for lunch tomorrow?)” that is configured with seven words.

TABLE 1

| Non-tangible speaker | | |
|---|---|---|
| feature (single) | | Example of similar sentence |
| Interjection | Interjection | Uhmm . . . nae-il jeom-sim-euro |
| | insertion | muol meok-ji |
| | | (Well . . . what to eat for lunch |
| | | tomorrow) |
| Postposition | Postpositional | Nae-il jeom-sim muol meok-ji |
| particle | particle | What to eat for lunch |
| | omission | tomorrow?) |
| | Postpositional | Nae-il-eun jeom-sim-euro |
| | particle | muol meok-ji (What to eat for |
| | addition | lunch tomorrow?) |
| Incomplete/correction | Incomplete | Nae-il jeom-sim-euro muol . . . |
| | | (What to eat for lunch . . . ) |
| | Correction | Nae-il jeom-sim-euro muo |
| | | meok-ji |
| | | (What to eat for lunch |
| | | tomorrow?) |
| Repetition | Repetition1 | Nae-il jeom-sim nae-il jeom- |
| | | sim-euro muol meok-ji |
| | | (What to eat for lunch for |
| | | lunch tomorrow?) |
| | Repetition2 | Nae-il ne-il jeom-sim-euro |
| | | muol meok-ji (What to eat for |
| | | lunch tomorrow tomorrow?) |
| Order | Change in | Muol meok-ji nae-il jeom- |
| | order | sim-euro |
| | | (What to eat tomorrow for |
| | | lunch?) |

In Table 1, an interjection insertion rule means generating a similar sentence by inserting an interjection to the beginning of a sentence, the end of a sentence, and between phrases. A postposition particle omission rule means generating a similar sentence by omitting a postposition particle included in a sentence. A postposition particle addition rule means generating a similar sentence by inserting a new postposition particle to a sentence. An incomplete rule means generating a similar sentence by omitting a subject, an object, or a predicate. A correction rule means generating a similar sentence by replacing a word or phrase included in a sentence with an abbreviation or fundamental form, etc. A repetition 1 rule means generating a similar sentence by repeating following clauses, words, or phrases. A repetition 2 rule means generating a similar sentence by repeating a unit that is smaller than a word (for example, phoneme, syllable part, syllable, word part, 1 syllable word, etc.). A change in order rule means generating a similar sentence by inversion of word order.

Table 2 shows an example of generating a similar sentence in combination of a plurality of speaker features.

TABLE 2

| Non-tangible speaker | |
|---|---|
| feature (plural) | Example |
| Interjection-correction | Nae-il jeom-sim-euro uhmm . . . muol |
| | meokji |
| | (What to eat well . . . for lunch |
| | tomorrow?) |
| Interjection-repetition | Nae-il jeom-sim jeom-sim-euro uhmm . . . |
| | muol meokji |
| | (What to eat well . . . for lunch for lunch |
| | tomorrow?) |
| Correction- repetition | Nae-il-eun jeom-sim jeom-sim-euro |
| | muol meok-ji |
| | (What to eat for lunch for lunch |
| | tomorrow?) |

A priority may be set between a plurality of speaker features. A priority between a plurality of speaker features may be preset, or may be adaptively determined according to feature information of a speaker.

In addition, a number of similar sentences generated in the similar sentence generating unit 130 may be limited to a preset number. The speaker feature using unit 134 may sequentially generate a similar sentence within a preset number on the basis of a priority between speaker features.

An interjection or postposition particle may be selected on the basis of a predefined interjection dictionary or postposition particle dictionary. In an example, Table 3 shows an example of interjection and postposition particle dictionaries.

TABLE 3

| | | |
|---|---|---|
| Interjection | Pleasure interjection: oh, | Impression interjection: |
| | hey, ah, oh my, oops, yah, | oh, hey, ah, oh my, oops |
| | yay, yo-ho, alley-oop, etc. | Will interjection: yay, |
| | | yo-ho, alley-oop, etc. |

| | |
|---|---|
| | Response interjection: yes, hello, what, so, may be, |
| | why, no, etc. |
| Postpositional | i/ka, ui, e, eke, eul/reul, euro/ro, wa/gua, a/ya |
| particle | |

Alternatively, an interjection or postposition particle may be variably applied according to feature information of a speaker. For example, types of interjections may be adaptively selected according to an age or region of a speaker.

In S250, the sentence filtering unit 140 may perform filtering for the similar sentence. In detail, the sentence filtering unit 140 may remove a duplicated sentence among similar sentences output from the similar sentence generating unit 130, or may remove an abnormal sentence on the basis of N-gram analysis.

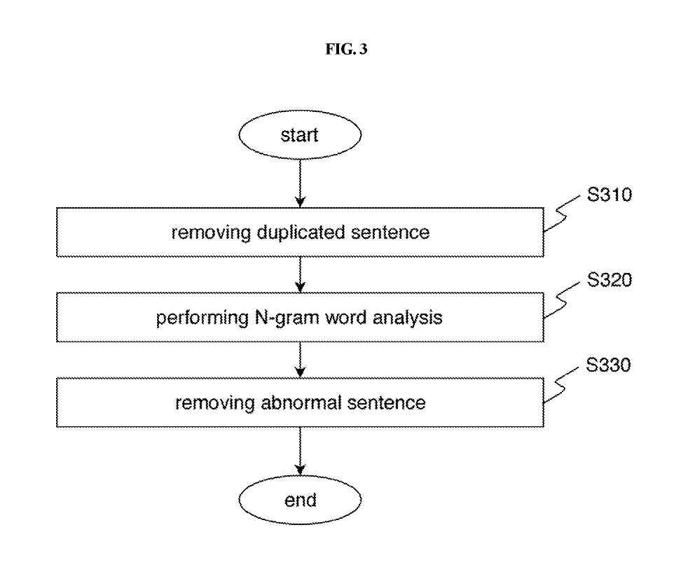

FIG. 3 is a view of a flowchart showing sentence filtering.

Referring to FIG. 3, first, in S310, a duplicated sentence may be removed among similar sentences. Herein, a duplicated sentence may mean a sentence identical to a basis sentence, or a sentence identical to a previously generated similar sentence.

When a duplicated sentence is removed, in S320, the sentence filtering unit performs N-gram word analysis for the similar sentence, and in S330, an abnormal sentence may be removed on the basis of the N-gram word analysis result. Herein, N-gram word analysis may be performed by verifying grammar for N consecutive words within a similar sentence. In an example, a similar sentence including N consecutive words that are determined as abnormal grammar may be determined as an abnormal sentence.

Grammar verification may be performed by using an N-gram word database. An N-gram word database may be established according to a frequency and an importance by using collected sentences where hundreds of millions of syntactic words are included. In an example, grammar verification may be performed on the basis of whether or not N consecutive words included in a similar sentence are present in an N-gram word database, or whether or not a consecutive occurrence probability of N consecutive words included in a similar sentence is equal to or greater than a preset threshold value, etc.

N is a natural number equal to or greater than 2, and N-gram may mean bigram, trigram or quadgram. Preferably, N-gram may be trigram.

Alternatively, in groups with poor language fluency (for example, older people), more ungrammatical sentences are used than others in real life. Accordingly, when performing N-gram analysis, N may be adaptively determined on the basis of feature information of a speaker. For example, an N value for older people may have a value smaller than an N value for young people.

An abnormal sentence may be artificially removed by a developer or manager. By artificially removing an abnormal sentence by a developer or manager, reliability of the generated similar sentence may increase.

Sentences that are finally output through sentence filtering may be used as reference sentences for machine learning. In an example, machine learning is conducted through voice recognition for reference sentences, and thus a voice recognition rate of an AI apparatus may be increased.

All of steps shown in a flowchart described with reference to FIGS. 2 and 3 are not essential for an embodiment of the present disclosure, and thus the present disclosure may be performed by omitting several steps thereof. In an example, in FIG. 2, a speaker feature is selected on the basis of feature information of a speaker. However, the learning sentence generating system may generate a similar sentence by using a predefined speaker feature without taking account into feature information of a speaker.

In addition, the present disclosure may also be practiced in a different order than that shown in FIGS. 2 and 3.

In addition, the learning sentence generating system and the similar sentence generating method using the same may be practiced by hardware, software or a combination thereof as described above. In addition, the learning sentence generating system may also be practiced on the basis of a machine apparatus such as a computing device.

Although the present disclosure has been described in terms of specific items such as detailed components as well as the limited embodiments and the drawings, they are only provided to help general understanding of the invention, and the present disclosure is not limited to the above embodiments. It will be appreciated by those skilled in the art that various modifications and changes may be made from the above description.

Therefore, the spirit of the present disclosure shall not be limited to the above-described embodiments, and the entire scope of the appended claims and their equivalents will fall within the scope and spirit of the invention.

What is claimed is:

1. A method of generating a similar sentence, the method comprising:
generating a first similar sentence by using a word similar to a word included in a basis sentence;
generating a second similar sentence of the basis sentence or the first similar sentence based on a speaker feature; and
determining whether or not the first similar sentence and the second similar sentence are valid.

2. The method of claim 1, wherein the speaker feature is selected based on feature information of a speaker, and the feature information is a feature related to at least one of an age, a gender, and a region of the speaker.

3. The method of claim 2, wherein when a plurality of speaker features is selected, the second similar sentence is generated by using a speaker feature in combination of at least two of the plurality of speaker features.

4. The method of claim 2, wherein when a plurality of speaker features is selected, at least one second similar sentence is sequentially generated based on a priority of the plurality of speaker features.

5. The method of claim 1, wherein the second similar sentence is generated by inserting an interjection to a beginning, an end, and between phrases of the basis sentence or the first similar sentence.

6. The method of claim 1, wherein the second similar sentence is generated by repeating a word or phrase included in the basis sentence or the first similar sentence.

7. The method of claim 1, wherein the determining of whether or not the first similar sentence and the second similar sentence are valid is performed based on whether or not the first similar sentence is identical to the basis sentence, or whether or not the second similar sentence is identical to the basis sentence or the first similar sentence.

8. The method of claim 1, wherein the determining of whether or not the first similar sentence and the second similar sentence are valid is performed by determining whether or not the first similar sentence and the second similar sentence are an abnormal sentence through N-gram word analysis.

9. The method of claim 8, wherein N is variably determined according to feature information of a speaker.

10. A system for generating a learning sentence, the system including:
a first similar sentence generating unit generating a first similar sentence by using a word similar to a word included in a basis sentence;
a second similar sentence generating unit generating a second similar sentence of the basis sentence or the first similar sentence based on a speaker feature; and
a sentence filtering unit determining whether or not the first similar sentence and the second similar sentence are valid.

11. The system of claim 10, further comprising a speaker feature selecting unit selecting the speaker feature based on feature information of a speaker, wherein the feature information relates to at least one of an age, a gender, and a region of the speaker.

12. The system of claim 11, wherein when a plurality of speaker features is selected, the second similar sentence generating unit generates the second similar sentence by using a speaker feature in combination of at least two of the plurality of speaker features.

13. The system of claim 11, wherein when a plurality of speaker features is selected, the second similar sentence generating unit sequentially generates at least one second similar sentence based on a priority between the plurality of speaker features.

14. The system of claim 10, wherein the second similar sentence is generated by inserting an interjection to a beginning, an end, between phrases of the basis sentence or the first similar sentence.

15. The system of claim 10, wherein the second similar sentence is generated by repeating a word or phrase included in the basis sentence or the first similar sentence.

16. The system of claim 10, wherein the sentence filtering unit determines whether or not the first similar sentence and the second similar sentence are valid by determining whether or not the first similar sentence is identical to the basis sentence, or whether or not the second similar sentence is identical to the basis sentence or the first similar sentence.

17. The system of claim 10, wherein the sentence filtering unit determines whether or not the first similar sentence and the second similar sentence are valid by determining whether or not the first similar sentence and the second similar sentence are an abnormal sentence through N-gram word analysis.

18. The system of claim 17, wherein N is variably determined according to feature information of a speaker.
